(19) United States
(12) Patent Application Publication
(10) Pub. No.: US 2006/0219783 A1
(43) Pub. Date: Oct. 5, 2006

(54) RFID tag system for an item between two locations

(75) Inventor: Richard A. Willis, Arlington, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: APSRFID, LLC

(21) Appl. No.: 11/098,798

(22) Filed: Apr. 5, 2005

(51) Int. Cl. G06Q 30/00; G06K 5/00; G07B 15/02

(52) U.S. Cl. 235/385; 235/384; 235/382

(57) ABSTRACT

Disclosed are systems, apparatuses, and methods for tracking an item between two locations. In one embodiment, a system for tracking and monitoring an item between two locations is comprised of an RF tag, an RF reader, and a central monitoring station. The RF tag is attached to an item and the RF reader is located in a controlled space. The RF tag transmits tag data and the RF reader receives the tag data. The RF reader transmits the tag data via a communication platform. A central monitoring station receives the tag data via the communication platform. The central monitoring station determines whether the item entered or exited the controlled space at a predetermined time and location based on the received tag data. Responsive to the item having not entered or exited the controlled space at the predetermined time and location, the central monitoring station transmits an alarm signal.

### TECHNICAL FIELD

The present invention relates to tracking and monitoring systems, and more importantly, the embodiments relate to systems, apparatus, and methods for tracking and monitoring an item that traverses between two locations.

### BACKGROUND OF THE INVENTION

Nowadays, children are being picked up in a vehicle to transport them to either a school or a daycare facility. The vehicle is a school bus, van, or car that transports the children from their home to the school or daycare facility. Children have been left on daycare vans when the daycare van was turned off and parked. The operator of the vehicle has at times left the children inside the vehicle for an extended period of time, which may expose the children to environmental conditions. This can result in physical harm and sometimes death to the children. There is an absence of anything out there that actually tracks whether a child has been left inside the vehicle.

From the above, it can be appreciated that it would be desirable to have a system, apparatus, and method for tracking a person between two locations.

### SUMMARY OF THE INVENTION

Disclosed are systems, apparatuses, and methods for tracking an item that traverses between two locations. In one embodiment, a system for tracking and monitoring an item between two locations is comprised of an RF tag, an RF reader, and a central monitoring station. The RF tag is attached to an item and the RF reader is located in a controlled space. The RF tag transmits tag data and the RF reader receives the tag data. The RF reader transmits the tag data via a communication platform. A central monitoring station receives the tag data via the communication platform. The central monitoring station determines whether the item entered or exited the controlled space at a predetermined time and location based on the received tag data. Responsive to the item having not entered or exited the controlled space at the predetermined time and location, the central monitoring station transmits an alarm signal.

In another embodiment, an RF reader is comprised of an antenna, a transceiver, and a computing device. The antenna receives a tag data in analog format from an RF tag. The transceiver receives the tag data from the antenna and converts the tag data from analog to digital format. The computing device receives the tag data in digital format from the transceiver. The computing device determines whether the RF reader is receiving tag data or stops receiving the tag data from the RF tag. This determination is communicated to a central monitoring station that determines whether the item entered or exited the controlled space at a predetermined time and location.

In another embodiment, a central monitoring station is comprised of a processing device and a memory that has an operating system and a monitoring station manager. The processing device interacts with the memory to facilitate the operating system in controlling the execution of at least the monitoring station manager. The monitoring station manager is stored in a computer-readable medium. The monitoring station manager comprises logics configured to receive data from an RF reader having at least data that an item entered or exited a controlled space; to store the reader data; to determine whether the item has entered or exited at a predetermined time and location; and to facilitate transmitting an alarm signal responsive to the item having not entered or exited the controlled space at the predetermined time and location.

In another embodiment, a method for tracking and monitoring an item between two locations is comprised of transmitting tag data from an RF tag; receiving the tag data; determining whether the RF tag entered a controlled space based on the received tag data; determining whether the RF tag exited a controlled space based on the received tag data; transmitting the tag data via a communication platform; receiving the tag ID data via the communication platform; determining whether the item entered or exited the controlled space at a predetermined time and location, and responsive to the item having not entered or exited the controlled space at the predetermined time and location, transmitting an alarm signal.

### BRIEF DESCRIPTION OF THE DRAWINGS

The disclosed systems, apparatuses, and methods can be better understood with reference to the following drawings. The components in the drawings are not necessarily to scale.

FIG. 1 is a perspective view of an embodiment of a system to which an item can be tracked and monitored between two locations

FIG. 2 is a schematic view of an embodiment of a system shown in FIG. 1.

FIG. 3 is a schematic view of an embodiment of the system shown in FIG. 2.

FIG. 4 is a schematic view of an embodiment of the system shown in FIG. 2.

FIG. 5 is a block diagram of an embodiment of the computing devices of the RF readers shown in FIG. 2.

FIG. 6 is a block diagram of an embodiment of a central monitoring station shown in FIG. 1.

FIG. 7A-B is a flow diagram that illustrates an embodiment of operation of the system shown in FIG. 2 in tracking an item between two locations.

FIG. 8 is a flow diagram that illustrates an embodiment of operation of an RF tag manager of the RF reader shown in FIG. 2.

FIG. 9 is a flow diagram that illustrates an embodiment of operation of a monitoring station manager of the central monitoring station shown in FIG. 2.

### DETAILED DESCRIPTION OF THE PREFERRED EMBODIMENT

Disclosed herein are systems, apparatuses, and methods to which an item can be tracked and monitored between two locations. The item can be, for example, but not limited to, a child, a nursing home patient, a prisoner, a medical patient, and any inanimate objects. In particular, an item is attached with an RF tag and a vehicle is attached with an RF reader. The item moves (or is moved) into the vehicle in which the RF reader detects the item being inside the vehicle. The vehicle transports the item from one location to another. Upon reaching the predetermined location, the item exits (or is moved) out of the vehicle. The RF reader detects that the item has moved out of the vehicle. The RF reader transmits data that the item enters and exits the vehicle to a central monitoring station so that the central monitoring station tracks and monitors the item. Example systems are first discussed with reference to the figures. Although the systems are described in detail, they are provided for purposes of illustration only and various modifications are feasible. After the exemplary systems have been described, examples of operation of the systems are provided to explain the manner in which the items can be tracked and monitored between two locations.

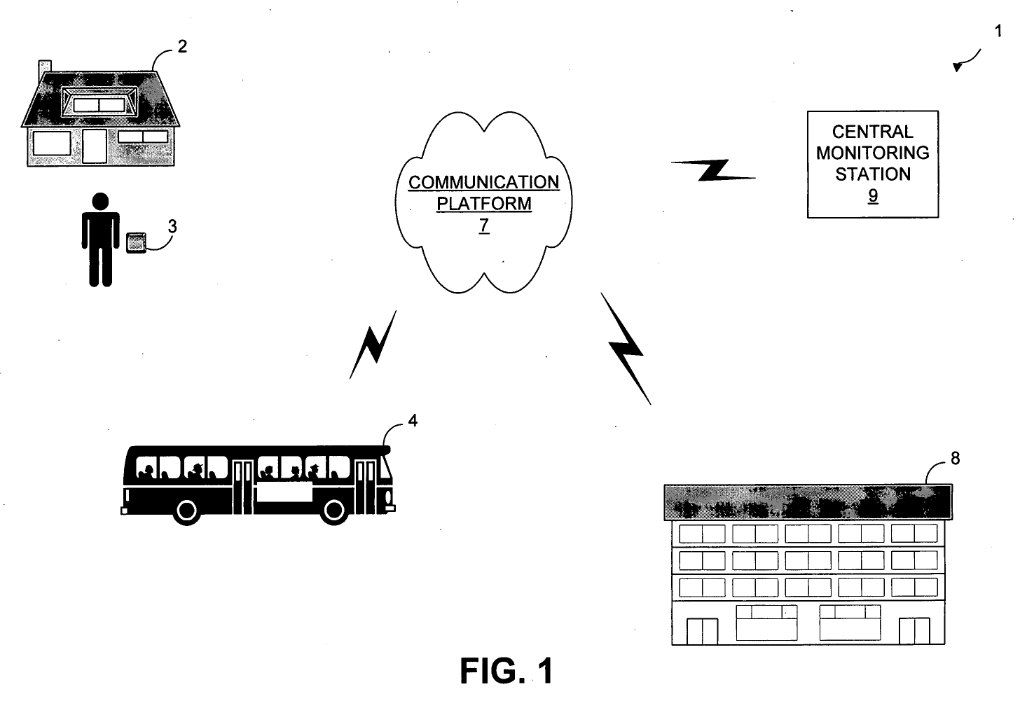

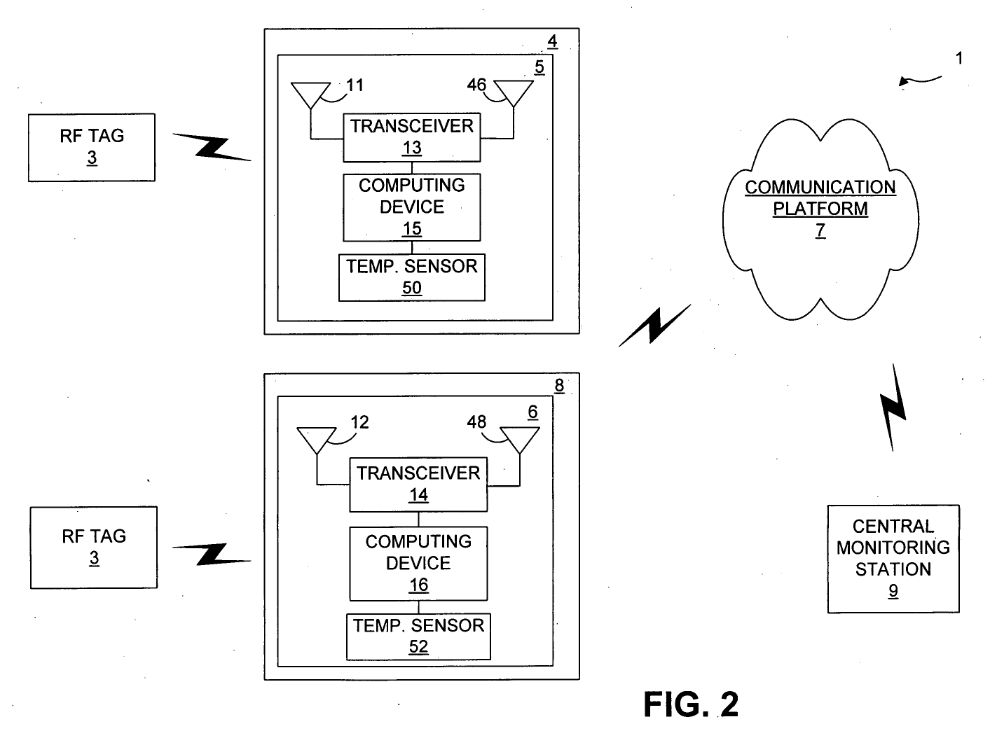

Referring now in more detail to the figures in which like reference numerals identify corresponding parts, FIG. 1 illustrates an exemplary system 1 in which an item can be tracked and monitored between two locations. As mentioned above, the item can be, for example but limited to, a child, a nursing home patient, a prisoner, a medical patient, and any inanimate objects. For exemplary purposes only, the item referred to is a child that is tracked and monitored from the child's home 2 to a day-care facility 8. Typically, the child is transported from the child's home to the day-care facility 8 by a vehicle 4. An RF tag 3 is attached to the child and when the child enters the vehicle 4, the system 1 detects the child in the vehicle 4 by using an RF reader 5 (FIG. 2) that detects the RF tag 3. The RF reader communicates to the central monitoring station 9 via a communication platform 7. The day-care facility 8 can also detect the child entering the facility 8 by using an RF reader 6 (FIG. 2). The central monitoring station 9 receives and uses the communicated data from the RF reader either from the vehicle 4 or the day-care facility 8 to track and monitor the child between two locations.

FIG. 2 is a schematic view of an embodiment of a system shown in FIG. 1. The system 1 generally comprises one or more RF tags 3, one or more RF readers 5, 6, a central monitoring station 9, and a communication platform 7. Typically, the central monitoring station 9 is programmed to associate an RF tag 3 with a child, which is attached with an RF tag 3. The RF readers 5, 6 are attached to a vehicle 4 and day-care facility 8. In one embodiment, the RF tag 3 can be passive and wait for the RF readers 5,6 to activate the RF tag. The RF readers 5, 6 periodically transmit an activating signal. When the RF tag 3 receives the signal from the RF readers 5, 6, the RF tag 3 transmits tag data to the RF readers 5, 6. The tag data can include the identification of the RF tag 3, which is associated with the child at the central monitoring station 9. In another embodiment, the RF tag 3 can be active and automatically transmits the tag identification data as soon as the RF tag 3 is attached to the child. In yet another embodiment, the RF tag 3 can be semi-passive and periodically transmits the tag data. The semi-passive tag 3 is capable of receiving signal from the RF readers 5, 6 that activate the tag 3 to transmit the tag data to the RF readers 5, 6.

The RF reader 5 comprises tag antenna 11, GPS antenna 46, transceiver 13, temperature sensor 50, and computing device 15. The RF reader 5 receives the tag data from the RF tag 3, via the antenna 11, which communicates the tag data to the transceiver 13. The tag data is converted from analog format to digital format by the transceiver 13. The transceiver 13 sends the digital formatted tag data to the computing device 15. The RF reader 5 can obtain its global position on the surface of the earth via the GPS antenna 46 and GPS software contained in the computing device 15. The temperature sensor 50 is electrically coupled to the computing device 15 and obtains the inside temperature of vehicle 4. The temperature sensor 50 transmits the temperature data to the computing device 15.

The computing device 15 associates the tag data to the time, date, global position, inside temperature, received flag or not-received flag, RF reader ID, and vehicle ID. The received or not-received flag is data that indicated whether the tag data is received or not received by the RF reader 5. The received or not-received flag can be used to determine whether the child has entered or exited the vehicle 4. The RF reader ID is data that indicated the identification of the RF reader to the central monitoring station 9. The vehicle ID is data that indicated the identification of the vehicle to the central monitoring station 9.

The RF reader 5 communicates to the central monitoring station 9 via the communication platform 7. The RF reader 5 transmits the tag data and the associated data to the central monitoring station 9 via the communication platform 7. The RF reader 5 can determine whether the RF tag 3 entered and exited the vehicle 4 based on receiving the tag data and not receiving the tag data. For example, if the RF reader 5 receives the tag data from the RF tag 3, the RF reader 5 communicates to the central monitoring station 9 that the child has entered the vehicle 4. If the RF reader 5 does not receive the tag data from the RF tag 3 for a predetermined time, the RF reader 5 communicates to the central monitoring station 9 that the child has exited the vehicle 9. In another embodiment, the vehicle 4 can further be attached with a motion detector (not shown) that detects the child entering or exiting the vehicle 4. The motion detector can also activate the RF reader 5 when the child enters the vehicle 4 to receive tag data from the RF tag 3, and vice versa.

The central monitoring station 9 receives the tag data and the associated data from the RF reader 5 via the communication platform 7. The central monitoring station 9 determines from the received data of the RF reader whether the child has entered or exited the vehicle 4 at predetermined time and location. Responsive to the child having not entered or exited the vehicle 4 at the predetermined time and location, the central monitoring station 9 can transmit an alarm signal to a responsible person, such as the child's parents, daycare authorities, and/or a government official/personnel. A central monitoring station 9 can further determine whether the child stayed in the vehicle 4 greater than a predetermined time period based on the received data from the RF reader 5. If the child stayed in the vehicle 4 greater than the predetermined time period, the central monitoring station 9 can transmit the alarm signal.

In an alternative embodiment, the RF reader 5 can be electrically coupled to the vehicle 4 to operate at least some electrical features of the vehicle depending on the technology that the vehicle 4 has. For example, if the child is in the vehicle for greater than a predetermined time, the central monitoring station 9 can communicate to the RF reader 5 to open or close the window of the vehicle 4 depending on the inside temperature of the vehicle 4. In one embodiment, the RF reader 5 can turn on the heater or air conditioner. The central monitoring station 9 can further program and reprogram the software store in the RF reader 5 to update or replace the time, date, vehicle ID, location ID, etc.

The system 1 further includes an RF reader 6 that is attached at a remote location 8, such as a day-care facility. The architecture for the RF reader 6 is similar to the architecture of the RF reader 5 described above, and therefore, includes antenna 12, GPS antenna 48, temperature sensor 52, transceiver 14, and computing device 16. The system 1 includes the communication platform, which can be a bi-directional satellite communication, Internet protocol communication, cellular communication, and short message network communication. The computing device 16 associates the tag data to the time, date, global position, inside temperature, received flag or not-received flag, RF reader ID, and remote location ID. The remote location ID is data that indicated the identification of the remote location to the central monitoring station 9.

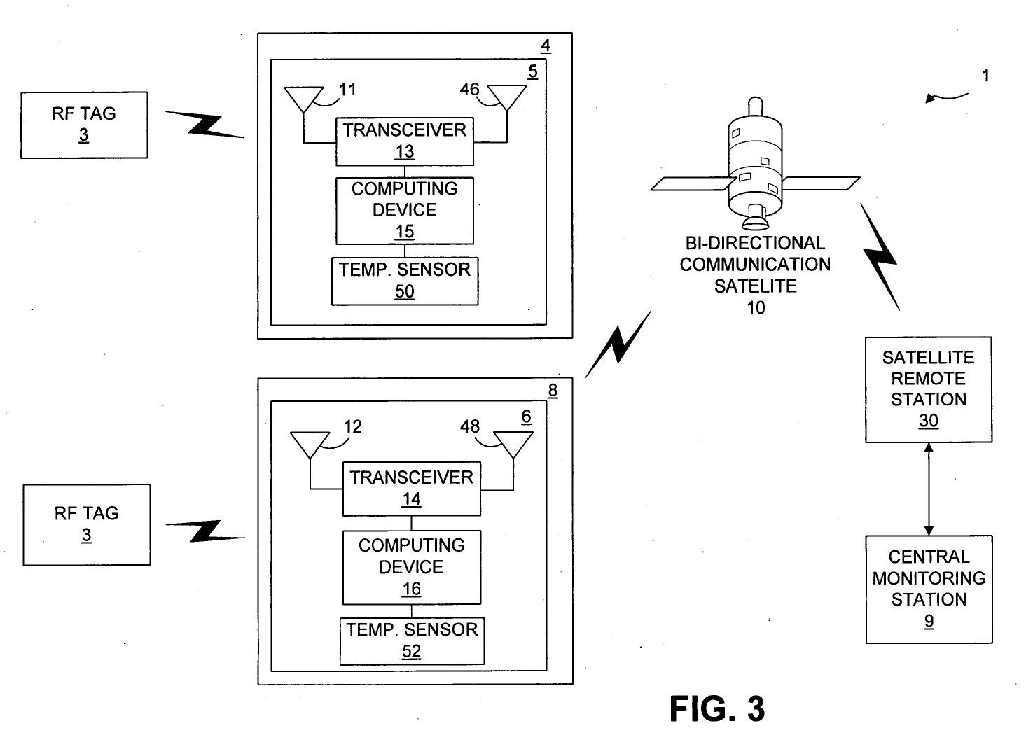

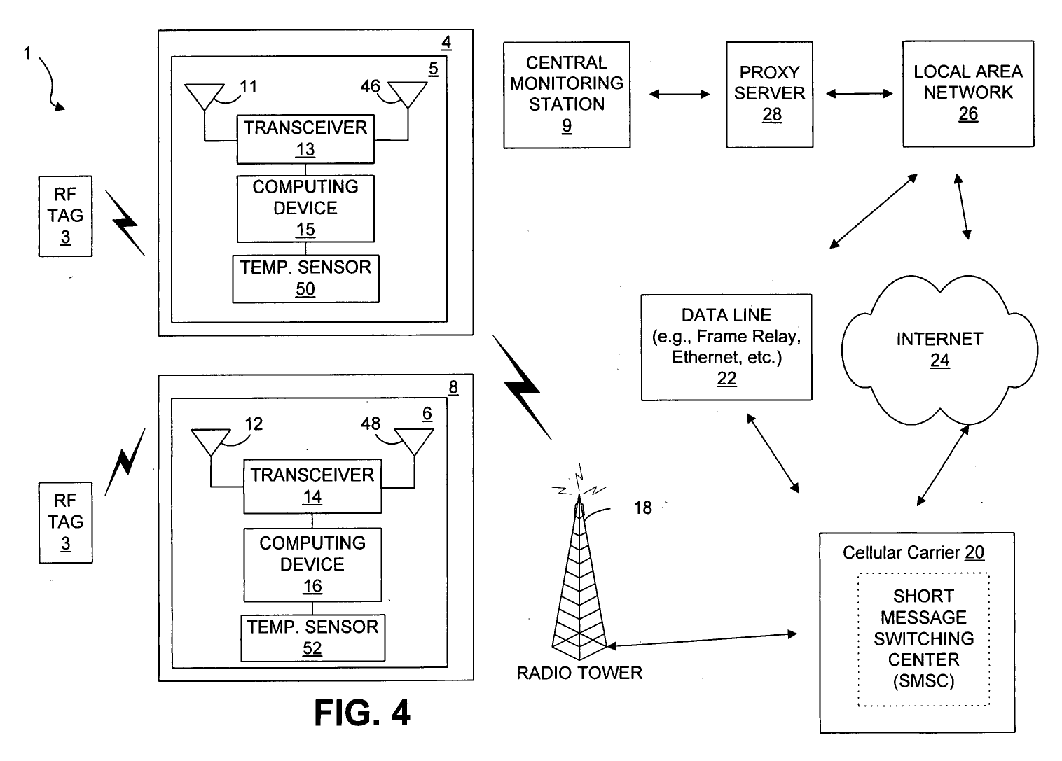

FIG. 3 illustrates an exemplary embodiment of system 1 shown in FIG. 2. The communication platform 7 of the system 1 uses a bi-directional communication satellite 10 and a satellite remote station 30. The RF readers 5, 6 can communicate to the central monitoring station 9 and vice versa via the bi-directional communication satellite 10 and the satellite remote station 30. For example, the RF readers 5, 6 transmit data to the bi-directional communication satellite 10 via antenna 11. The bi-directional communication satellite 10 relays the data to the GPS remote station 30, which sends the data to the central monitoring station 9. FIG. 4 illustrates an exemplary embodiment of system 1 shown in FIG. 2.

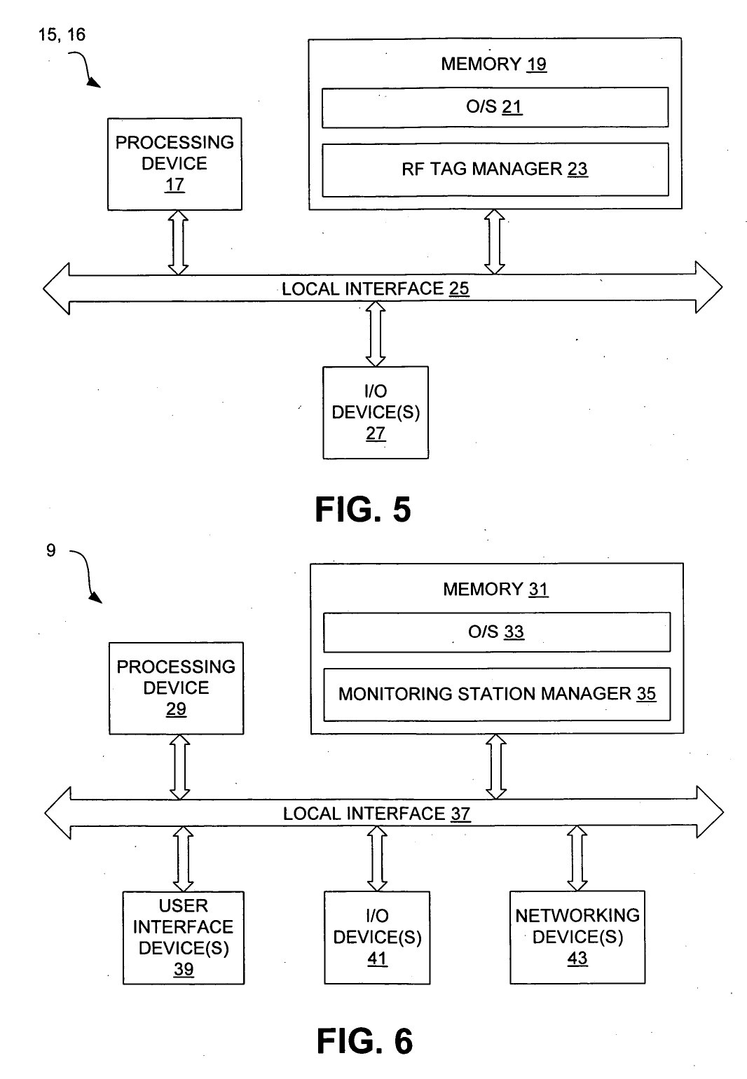

FIG. 4 illustrates one embodiment of the communication platform 7 to facilitate communication between the RF readers 5, 6 and central monitoring station 9 using radio tower 18, cellular carrier 20, data line 22, Internet 24, local area network 26, and proxy server 28. FIG. 5 is a block diagram illustrating an exemplary architecture for the computing devices 15, 16 of the RF readers 5, 6 shown in FIG. 1. As indicated in FIG. 5, the computing devices 15, 16 comprise a processing device 17, memory 19, and one or more I/O devices 27, each of which is connected to a local interface 25. The processing device 17 can include any custom made or commercially available processor, a central processing unit (CPU) or an auxiliary processor among several processors associated with the computing devices 15, 16, a semiconductor based microprocessor (in the form of a microchip), or a macroprocessor. The memory 19 can include any one or a combination of volatile memory elements (e.g., random access memory (RAM, such as DRAM, SRAM, etc.)) and nonvolatile memory elements (e.g., ROM, hard drive, tape, CDROM, etc.).

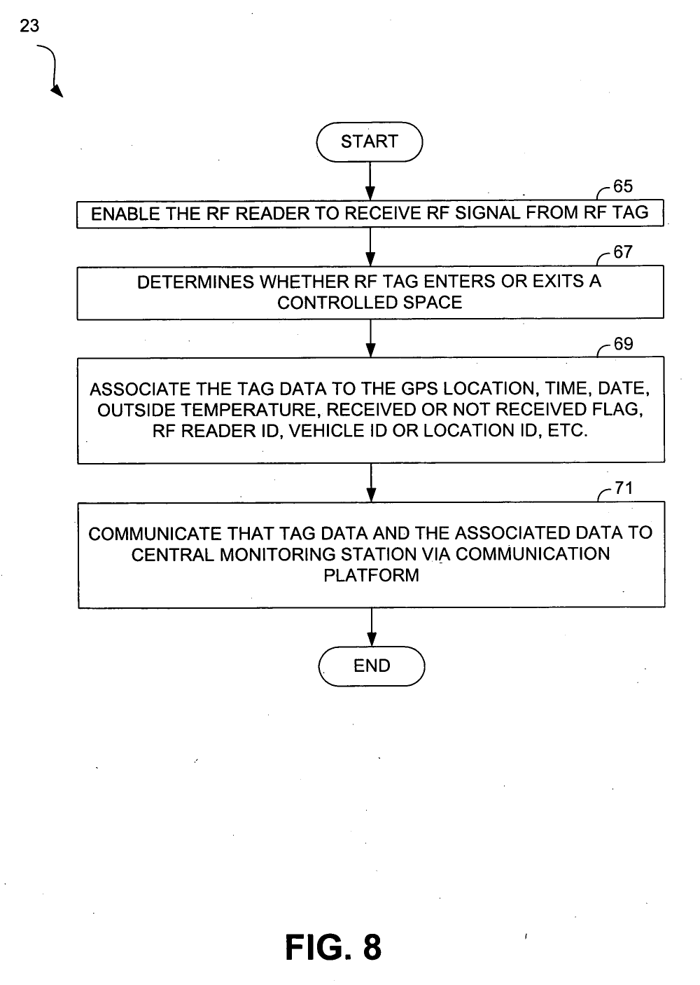

The one or more I/O devices 27 comprise components used to facilitate connection of the computing devices 15, 16 to other devices and therefore, for instance, comprise one or more serial, parallel, small system interface (SCSI), universal serial bus (USB), or IEEE 1394 (e.g., Firewire™) connection elements. The memory 19 normally comprises various programs (in software and/or firmware) including an operating system (O/S) 21 and an RF tag manager 23. The O/S 21 controls the execution of programs, including the RF tag manager 23, and provides scheduling, input-output control, file and data management, memory management, and communication control and/or related services. The RF tag manager 23 facilitates monitoring and tracking of an item between two locations. Typically, the RF tag manager 23 receives data from the RF tag 3 and associates the data to time, date, inside temperature, RF reader ID, vehicle ID and/or location ID, etc. The RF tag manager 23 further transmits the tag data and associated data to the central monitoring station 9 to facilitate tracking and monitoring the item between two locations via the communication platform 7. Operation of the RF tag manager 23 is described in relation to FIG. 8.

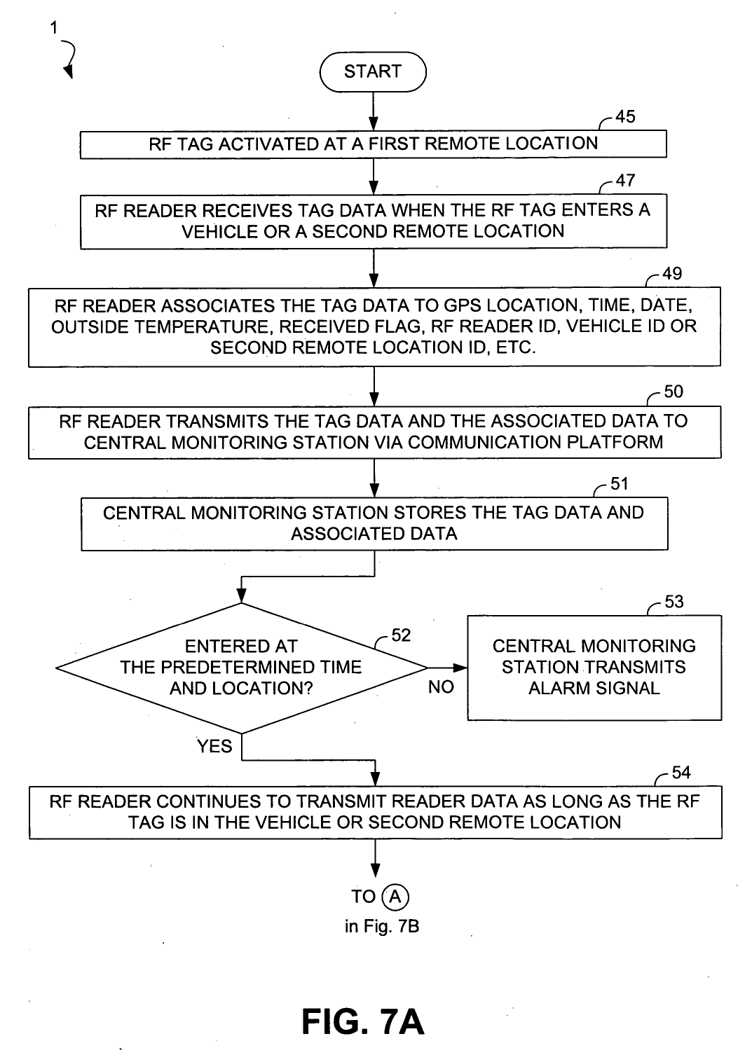

FIG. 6 is a block diagram illustrating an exemplary architecture for the central monitoring station 9 shown in FIG. 1. The architecture for the central monitoring station 9 is similar to the architecture of the computing devices 15, 16 of the RF readers 5, 6 described above and therefore includes a processing device 29, and one or more I/O devices 41, each of which is connected to a local interface 37.

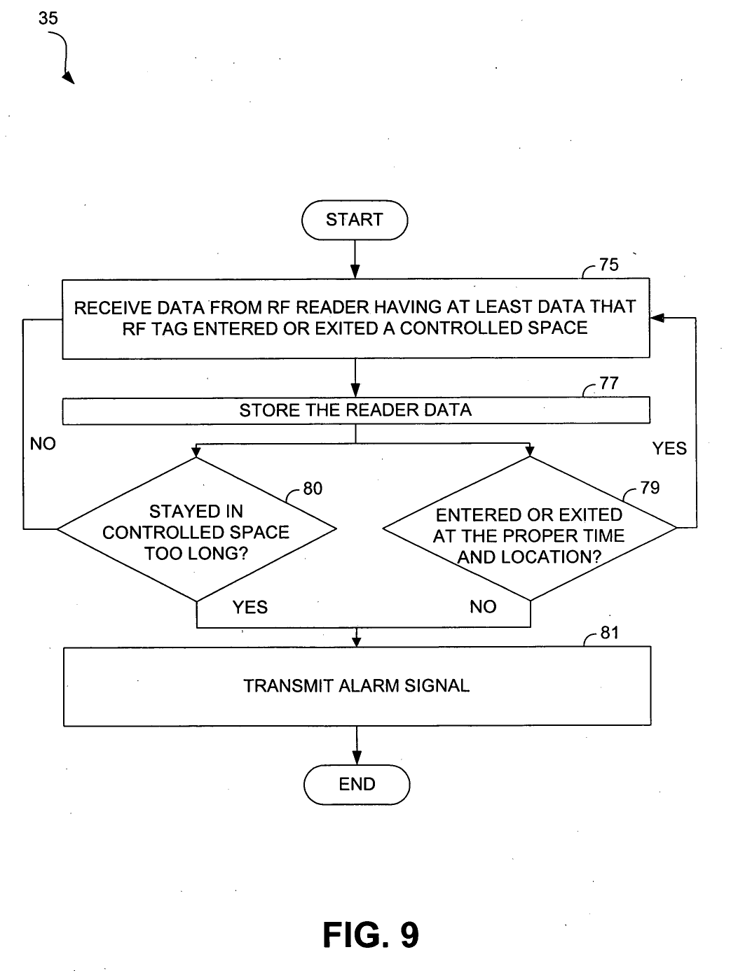

The memory 31 in the central monitoring station 9, however, includes a monitoring station manager 35 that facilitates tracking and monitoring an item between two locations. Typically, the monitoring station manager 35 receives data from the RF reader and uses the data to track and monitor the item between two locations via the communication platform 7. Operation of the monitoring station manager 35 is described in relation to FIG. 9.

The architecture for the central monitoring station 9 further includes one or more user interface devices 39 and networking devices 43. The one or more user interface devices 39 comprise those components with which the user (e.g., administrator) can interact with the central monitoring station 9. Where the central monitoring station 9 comprises a server computer or similar device, these components can comprise those typically used in conjunction with a PC such as a keyboard and mouse.

The networking devices 43 comprise the various components used to transmit and/or receive data over the communication platform 7, where provided. By way of example, the networking devices 43 include a device that can communicate both inputs and outputs, for instance, a modulator/demodulator (e.g., modem), a radio frequency (RF) or infrared (IR) transceiver, a telephonic interface, a bridge, a router, as well as a network card, etc.

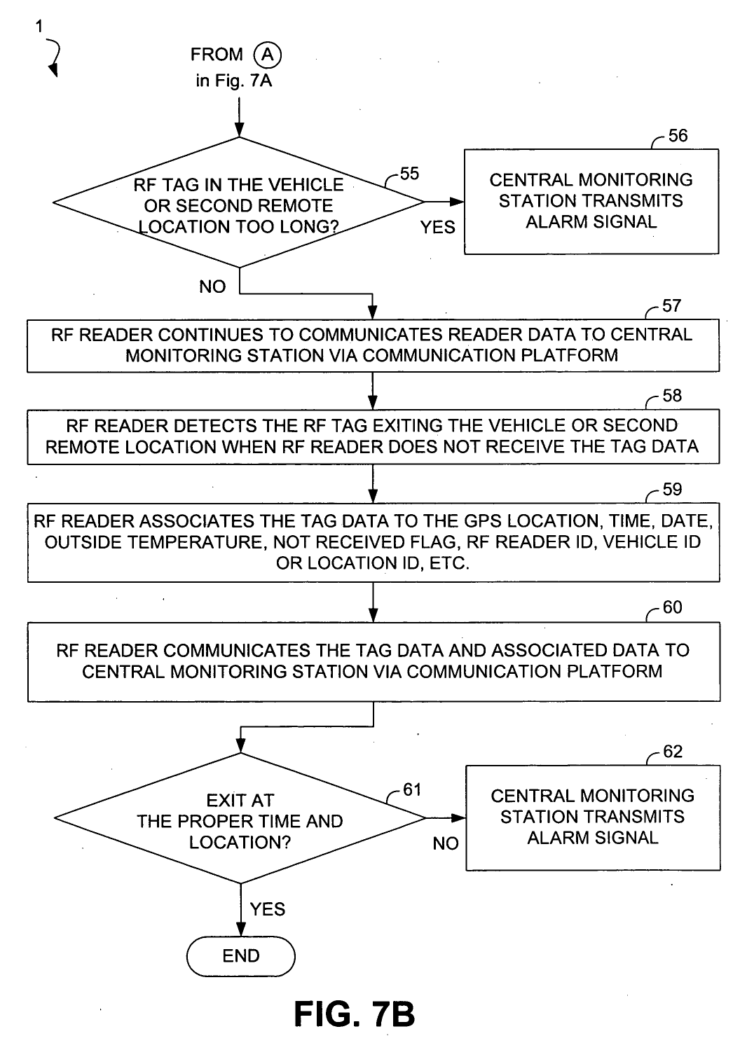

FIGS. 7A-B illustrate an example of operation of the system 1 in monitoring and tracking an item between two locations. With system 1, a child can be tracked and monitored whether the child entered or exited a vehicle or a remote location at a predetermined time and location. Further, a responsible person can be alerted when a child stayed in the vehicle or the remote location for a predetermined time period.

Beginning with block 45, an RF tag 3 is activated at a first remote location, e.g., the child's home 2. In block 47, RF readers 5, 6 receive tag data from the RF tag 3 when the child enters a vehicle 4 or a second remote location 8. In block 49, the RF readers 5, 6 associate the tag data to the received flag as well as to the GPS location, time, date, inside temperature, received flag, RF reader ID, vehicle ID or second remote location ID, etc. The received flag indicates that the RF readers 5, 6 receive the tag data from the RF tag 3.

In block 50, the RF readers 5, 6 transmit the tag data and the associated data to a central monitoring station 9 via a communication platform 7. In block 51, the central monitoring station 9 stores the tag data and the associated data in memory. In block 52, the central monitoring station 9 determines whether the child entered the vehicle 4 or second remote location 8 at a predetermined time and location based on the received tag data and associated data.

For example, when the child is being transported from the child's home 2 to the day-care facility 8 in the morning, the central monitoring station 9 can expect to receive the child's tag data from RF reader 5 when vehicle 4 picks up the child between 7:00 am to 7:15 am at the child's home 2. The central monitoring station 9 can also expect to receive the child's tag data from RF reader 6 when the child enters the day-care facility 8 between 8:00 am to 8:15 am. If the child did not enter the vehicle 4 or the day-care facility 8 at the predetermined time and location, the central monitoring station 9 transmits an alarm signal that the child did not enter the vehicle 4 or the day-care facility 8 to a responsible person, such as a parent, school personnel, day-care facility personnel, or government official/personnel.

In block 54, the RF readers 5, 6 continue to transmit tag data and associated data as long as the RF tag 3 that is attached to the child is in the vehicle 4 or the second remote location 8. Continuing now to reference A in FIG. 7B, the central monitoring station 9 determines whether the child stayed in the vehicle 4 or the second remote location 8 for a predetermined time period. In other words, the central monitoring station 9 determines whether the child is in the vehicle for too long such that the child is possibly left in the vehicle 4 or second remote location 8 without the vehicle operator or remote location personnel being aware. For example, the central monitoring station 9 continues to receive the tag data and the associated data from the RF reader 5 for over an hour in vehicle 4.

In block 56, if a child has been left behind in the vehicle 4 or second remote location 8, the central monitoring station 9 transmits an alarm signal that the child has been left behind in the vehicle 4 or second remote location 8 to a responsible person, such as a parent, school personnel, day-care facility personnel, or government official/personnel. In an alternative embodiment, the central monitoring station 9 can instruct the RF readers 5, 6 to cause the vehicle 4 or second remote location 8 to, for example, turn on the heater or air conditioner depending on the inside temperature of the vehicle 4 or second remote location 8.

If the central monitoring station 9 determines that the child is in the vehicle 4 or the second remote location 8 that is not greater than a predetermined time period (or not left behind), the central monitoring station 9 continues to receive the tag data and associated data from the RF readers 5, 6 via the communication platform 7, as in block 57. When the RF readers 5, 6 do not receive the tag data from the RF tag 3 for a predetermined time period of, for example, five minutes, the RF readers 5, 6 detect that the child has exited the vehicle 4 or second remote location 8, shown in block 58. The RF reader 5, 6 associates the tag data to the not-received flag as well as to the GPS location, time, date, inside temperature, RF reader ID, vehicle ID or second remote location ID, etc. as shown in block 59. The not-received flag indicates that the RF readers 5, 6 stop receiving tag data from the RF tag 3.

The RF readers 5, 6 communicate the tag data and associated data to the central monitoring station 9 via the communication platform 7, as shown in block 60. The central monitoring station 9, shown in block 61, determines whether the child has exited the vehicle 4 or second remote location 8 at a predetermined time and location. For example, when the vehicle 4 drops the child at the day-care facility 8 in the morning, the central monitoring station 9 can expect to receive the tag data associated to the not-received flag, the RF reader 5 attached to the vehicle 4, and GPS position near the day-care facility 8 between 8:00 am to 8:15 am. When the child leaves the day-care facility 8 in the afternoon, the central monitoring station 9 can expect to receive the tag data associated to the not-received flag, the RF reader 6 attached to the facility 8, and GPS position near the day-care facility 8 between 4:00 pm to 4:15 pm. The central monitoring station 9 can further expect receiving the tag data associated to the not-received flag, the RF reader 5 attached to the vehicle 4, and GPS position near the child's home 2 between 5:00 pm to 5:15 pm. If the child did not exit the vehicle 4 or second remote location 8 at a predetermined time and location, the central monitoring station 9 transmits an alarm signal, as indicated in block 62.

In an alternative embodiment, the system 1 can further track and monitor the route of the vehicle 4 that transports the child from the child's home 2 to the day-care facility 8. This is called route deviation. If the vehicle 4 deviates from a predetermined route, the central monitoring station 9 can send an alarm signal.

FIG. 8 provides an example of operation of the RF tag manager 23 of the RF readers 5, 6. Beginning with block 65, the RF tag manager 23 can enable the RF readers 5, 6 to receive tag data from the RF tag 3 in a controlled space. In an alternative embodiment, the RF tag manager 23 can first send a signal to trigger the RF tag 3 to transmit the tag data and then receive the tag data of the RF tag 3. In block 67, the RF tag manager 23 determines whether the RF tag 3 that is attached to a child enters or exits the controlled space. The RF tag manager 23 determines that the child has entered the controlled space by receiving the tag data from the RF tag. On the other hand, the RF tag manager 23 determines that the child has exited the controlled space by not receiving the tag data anymore from the RF tag.

In block 69, the RF tag manager 23 associates the tag data to the received flag (or not-received flag), GPS location, time, date, inside temperature, RF reader ID, vehicle ID or location ID, etc. In block 71, the RF tag manager 23 communicates the tag data and the associated data to the central monitoring station 9 via a communication platform 7 so that the central monitoring station 9 can track and monitor the child between two locations.

FIG. 9 provides an example of operation of the monitoring station manager 35 of the central monitoring station 9. Beginning with block 75, the monitoring station manager 35 receives data from the RF readers 5, 6. In block 77, the monitoring station manager 35 stores the data in memory of the central monitoring station 9. In block 79, the monitoring station manager 35 determines whether the child that is attached with the RF tag 3 exited or entered a controlled space at a predetermined time and location based on the received data from the RF readers 5, 6. In block 80, the monitoring station manager 35 further determines whether the child stayed in the controlled space for greater than a predetermined time period based on the received data from the RF readers 5, 6. If the child entered or exited the controlled space at the predetermined time and location or did not stay in the controlled space for greater than the predetermined time period, the monitoring station manager 35 continues to receive data from the RF readers 5, 6, as indicated in block 75. If the child did not enter or exit the controlled space at the predetermined time and location or stayed in the controlled space for greater than the predetermined time period, the monitoring station manager 35 transmits an alarm signal, as indicated in block 81. In an alternative embodiment, the monitoring station manager 35 can instruct the central monitoring station 9 to transmit signal to the RF reader 5, 6 so that the RF reader can cause the controlled space to, for example, turn on the heater or air conditioner depending on the inside temperature of the controlled space.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A system for tracking and monitoring an item between two locations, the system comprising:
an RF tag that is attached to an item and transmits tag data;
an RF reader that is receives the tag data from the RF tag, wherein the RF reader transmits the tag data via a communication platform; and
a central monitoring station that receives the tag data via the communication platform, the central monitoring station determines whether the item entered or exited the controlled space at a predetermined time and location based on the received tag data, wherein responsive to the item having not entered or exited the controlled space at the predetermined time and location, the central monitoring station transmits an alarm signal.

2. The system of claim 1, wherein the RF tag is passive that is triggered by the RF reader to transmit the tag ID data.

3. The system of claim 1, wherein the RF tag is active that transmits tag ID data.

4. The system of claim 1, wherein the RF reader is capable of obtaining its global position on the surface of the earth, the RF reader associating the tag ID data with its global position and transmitting them via the communication platform.

5. The system of claim 1, wherein the RF reader associates the tag data with one of time, date, inside temperature, received or not received flag, RF reader ID, vehicle ID or location ID data, and transmits the tag data and the associated data via the communication platform.

6. The system of claim 1, wherein the RF reader activates the RF tag to transmit the tag ID data.

7. The system of claim 1, wherein the communication platform is one of bi-directional satellite communication, Internet protocol communication, cellular communication, and short message network communication.

8. The system of claim 1, wherein the controlled space is one of a vehicle and a facility building.

9. The system of claim 5, wherein the central monitor system determines whether the item remained in the controlled space greater than a predetermined time period based on the tag data and the associated data, and responsive to the item remaining in the controlled space greater than a predetermined time period, the central monitor system transmits an alarm signal.

10. The system of claim 5, wherein the central monitoring station, determines whether the item entered or exited the controlled space at a predetermined time and location based on the tag data and the associated data.

11. An RF reader comprising:
an antenna that receives tag data in analog format from an RF tag that is attached to an item;
a transceiver that receives the tag data from the antenna and converts the tag ID data from analog to digital format; and
a computing device that receives the tag data in digital format from the transceiver;
wherein the computing device determines whether the RF reader is receiving tag data or stops receiving the tag data from the RF tag, the computing device being capable of communicating the determination of either the RF reader is receiving tag data or stops receiving the tag data from the RF tag, to a central monitoring station via that determines whether the item entered or exited the controlled space based on the tag data.

12. The RF reader of claim 1 1, wherein the computing device is capable of obtaining its global position on the surface of the earth via the transceiver, the antenna, and global positioning satellites, the computing device associating the tag data with its global position and transmitting them via communication platform to the central monitoring station.

13. The RF reader of claim 11, wherein the computing device associates the tag data to one of time, date, inside temperature, received or not received flag, vehicle ID or location ID, and transmits them via communication platform.

14. The RF reader of claim 13, wherein the computing device is capable of communicating tag data and the associated data to the central monitoring station that determines whether the RF tag entered and exited the controlled space at a predetermined time and location based on the tag data and associated data.

15. The RF reader of claim 11, wherein the computing device is capable of activating the RF tag to transmit the tag data via the transceiver and the antenna.

16. The RF reader of claim 1 1, wherein the controlled space is one of a vehicle and a facility building.

17. A central monitoring station comprising:
a processing device; and
a memory having an operating system and a monitoring station manager, the processing device interacting with the memory to facilitate the operating system in controlling the execution of at least the monitoring station manager,
wherein monitoring station manager stored in a computer-readable medium, the manager comprising:
logic configured to receive data from an RF reader;
logic configured to store the reader data;
logic configured to determine whether the item has entered or exited at a predetermined time and location based on the reader data; and
logic configured to facilitate transmitting an alarm signal responsive to the item having not entered or exited the controlled space at the predetermined time and location.

18. The central monitoring station of claim 17, wherein the monitoring station manager further comprises logic configured to determine whether the item remained in the controlled space greater than a predetermined time period based on the reader data, and if the item remains in the controlled space greater than a predetermined time period, the monitoring station manager facilitates transmitting an alarm signal.

19. The central monitoring station of claim 17, wherein the reader data comprises a tag data from an RF tag, time, date, inside temperature, received or not received flag, vehicle ID, and location ID.

20. A method for tracking and monitoring an item between two locations, the method comprising:
transmitting tag data from an RF tag that is attached to an item;
receiving the tag data;
determining whether the RF tag entered a controlled space based on the received tag data;
determining whether the RF tag exited a controlled space based on the not receiving the tag data;
transmitting the tag data via a communication platform;
receiving the tag data via the communication platform;
determining whether the item entered or exited the controlled space; and
responsive to the item having not entered or exited the controlled space, transmitting an alarm signal.

21. The method of claim 20, further comprising activating the RF tag to transmit the tag data.

22. The method of claim 20, further comprising obtaining a global position of the controlled space on the surface of the earth, associating the tag data to the global position, and transmitting them via the communication platform.

23. The method of claim 22, further comprising associating the tag data to one of time, date, inside temperature, received or not received flag, vehicle ID, and location ID data and transmitting them via communication platform.

24. The method of claim 23, further comprising:
determining whether the item entered or exited the controlled space at predetermined time and location based on the tag data and the associated data; and
responsive to the item having not entered or exited the controlled space at a predetermined time and location, transmitting an alarm signal.

25. The method of claim 23, further comprising:
determining whether the item stayed in the controlled space greater than a predetermined time period based on the tag data and the associated data; and
responsive to the item staying in the controlled space greater than the predetermined time period, transmitting an alarm signal.

26. The method of claim 20, further comprising detecting an item entering or exiting the controlled space via a motion detector, the motion detector being capable of activating the RF reader to receive data from the RF tag when an item enters the controlled space.
